(19) United States
(12) Patent Application Publication
(10) Pub. No.: US 2006/0080219 A1
(43) Pub. Date: Apr. 13, 2006

(54) Systems and methods of obtaining trading exclusivity in electronic trading systems

(76) Inventors: Howard W. Lutnick, New York, NY (US); Michael Sweeting, Aldershot (GB); Joseph Noviello, New York, NY (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/195,156

(22) Filed: Aug. 1, 2005

Related U.S. Application Data
(60) Provisional application No. 60/604,535, filed on Aug. 25, 2004.

(51) Int. Cl. G06Q 40/00

(52) U.S. Cl. 705/37

(57) ABSTRACT

Systems and methods for obtaining trading exclusivity in electronic trading systems are provided. The systems and method preferably provide criteria for determining whether exclusivity to certain incoming orders is available. Suitable electronic trading systems for implementation of such methods include, but are not limited to, hit/lift exclusive priority systems, price time priority systems, order allocation systems, and request for quote systems.

### CROSS REFERENCE TO RELATED APPLICATION

This application claims the benefit of U.S. Provisional Application No. 60/604,535, filed Aug. 25, 2004.

### INTRODUCTION

The present invention relates to electronic systems and methods for obtaining trading exclusivity in electronic trading systems.

### BACKGROUND OF THE INVENTION

In electronic trading systems that include bids and offers for items, a bid and offer that is entered by a participant may typically be entered as available (referred to alternatively hereinafter as “clear”) to trade to other participants. Nevertheless, certain known trading systems may only allow a bid or offer to be clear to other participants under certain conditions. For example, a Bid/Offer may be available only to the current market participants, i.e., those with current commitments (bids/offers), or, alternatively, may be available only to the current market participants showing the best bid or the best offer, respectively. Accordingly, preferably only those customers with current participation can hit or lift these incoming entries. Such bids/offers may be considered unclear—i.e., not available to all trading participants.

In one type of trading system, the uncleared bids become available to participants other than the current participants only after a preset or predetermined time interval has expired (tracked by a internal system clock or other suitable device).

One important component that relates to cleared and uncleared bids and offers in electronic trading systems is order exclusivity. In certain circumstances, a participant having a current bid or offer may be entitled to exclusive rights to trade with an incoming order only if certain criteria are met.

It would be desirable to provide systems and methods that further define the criteria for providing exclusive rights to an incoming order.

### SUMMARY OF THE INVENTION

It would be desirable to provide systems and methods that further define the criteria for providing exclusive rights to an incoming order.

A method for trading an item in an electronic trading system according to the invention is preferably provided. The method includes receiving an incoming order and determining whether a current order, the current order being contra to the incoming order, satisfies a set of predetermined criteria. If the predetermined criteria satisfies the predetermined criteria, then a participant associated with the current order obtains exclusive rights to trade with the incoming order and the system presents the incoming order for trading exclusively to the participant associated with the current order.

### BRIEF DESCRIPTION OF THE DRAWINGS

Further features of the invention, its nature and various advantages will be apparent from the following detailed description of the preferred embodiments, taken in conjunction with the accompanying drawings, in which like reference characters refer to like parts throughout, and in which:

FIG. 1 is an illustration of an electronic implementation of a system in accordance with some embodiments of the present invention;

FIG. 2 is an illustration, in greater detail, of an electronic implementation of a system in accordance with some embodiments of the present invention; and

FIG. 3 is an illustration of an electronic trading interface in accordance with some embodiments of the present invention.

FIGS. 4-9 are flowcharts of various methods according to the invention.

### DETAILED DESCRIPTION OF THE INVENTION

In one embodiment of the invention, an exclusive right to trade against an incoming contra order may be provided to a current participant if such participant satisfies a minimum size order requirement. If the current participant satisfies the minimum size order requirement, then only that current participant (assuming the participant has price and/or time priority over similarly qualifying participants—i.e., in price/time priority systems, the best priced order has priority over other orders, and, in the case of two identical prices, the order being first in time has priority) may be rewarded with exclusivity to trade against the incoming contra order. Thus, the incoming order may only be maintained in an uncleared state if there exists a contra order that meets a particular size threshold.

In another embodiment of the invention, this minimum size requirement may be relative to the incoming order—e.g., the size of the current order must be at least some portion or percentage of the size of the incoming contra order.

Alternatively, this minimum size requirement may be relative to the incoming order size and may also be required to meet or exceed a pre-determined system size threshold. For example, with respect to an incoming order to sell 50 million, wherein a minimum system size threshold of 30 million exists and a minimum percentage requirement of the incoming order of 50% exists, a participant, in order to qualify for exclusivity with respect to the incoming 50 million order, must show a current buy order (or alternatively, any order whether contra to the incoming order or not) that exceeds at least a portion or percentage of the incoming 50 million—e.g., 50% of the 50 million—and the participant must satisfy a minimum system size threshold—e.g., at least 30 million—in order to obtain exclusivity. Thus, in this particular example, a buy order of 30 million or more entitles the participant to exclusivity with respect to the incoming 50 million order (assuming, again, that the participant has price/time priority over other similarly qualifying participants).

In an alternative embodiment a participant may be required to have a current order within a predetermined delta of the current best bid or the current best offer, (the current best bid and best offer represent the headline price for the particular item) or some combination of the threshold size and the predetermined delta in order to have exclusivity with respect to an incoming bid or offer. Alternatively, the delta may be a price difference or a percentage difference between the participant's current order price and the incoming order price. Thus, in systems and methods according to these embodiments of the invention, a participant may obtain exclusive rights to incoming orders only when the participant has a current order that satisfies certain predetermined or otherwise suitable criteria.

Furthermore, a participant's exclusive right to trade with incoming orders may depend on the size or price/time priority of the current participant's order with respect to other orders in the system. The incoming order, in some embodiments, may only be partially available to a participant depending on the size, price and time entry of that participant's order.

Additionally, in some embodiments of the invention, the incoming order may only be displayed to the current participant with rights to the incoming order, or alternatively, may be displayed in part where a participant has exclusive rights to trade only with a limited portion of the incoming order. For example, when an order of 12 million is made partially available—e.g., for 5 million—to a participant, then only 5 million may be displayed exclusively to that participant. The remaining 7 million may be displayed as clear to trade to all participants.

When that current participant, who has exclusive rights to the 5 million, elects to trade (either buy or sell) the 5 million described in the above example, this may initiate a trading state wherein the participant associated with the incoming order and the participant who elected to trade with the incoming order have exclusive rights to trade with each other.

In another embodiment of the invention relating to rights to trade with incoming orders, all of the orders contra to the incoming order may be prioritized according to size whereby the largest size bidder/offeror (who, in one embodiment, may not be the highest price bidder/lowest price offeror) may enjoy the right to exclusively trade with the incoming order. In some embodiments, this rule may only be implemented when the incoming order is the best bid or offer, respectively, and is also within a predetermined delta of the best contra order. Thus, with respect to rights to trade against incoming orders, the usual price/time priority may be overridden in favor of order size priority.

In another aspect of systems and methods according to the invention, all incoming bids and offers may be considered clear to all participants except under certain conditions. For example, all incoming bids and offers may be considered clear to all participants unless the incoming bid or offer meets a minimum size to qualify for exclusivity—i.e., to be available only to a select participant or, alternatively, to a group of select participants. Thus, the incoming order may only be maintained in an uncleared status if the incoming order meets a particular size threshold. For example, an incoming order must be for 10 million in order to only be shown to, or, alternatively, to only be available to be traded by, select participants or to be entitled to other suitable benefits.

In one embodiment of the invention, the minimum size threshold of incoming orders may be relative—e.g., the incoming order must be a certain percentage of the largest currently available contra order.

In an alternative embodiment, the incoming order must be within a predetermined delta of the best contra order, or the incoming order must satisfy some combination of the threshold size and the predetermined delta in order to only be shown to or, alternatively, to only be available to be traded by, select participants.

With respect to yet another embodiment of the invention, hidden size—i.e., a portion of the order that is not shown to the rest of the participants, but, if acted upon, is tradable—may also count toward satisfying the minimum size requirement of the order either as a current order or as an incoming order.

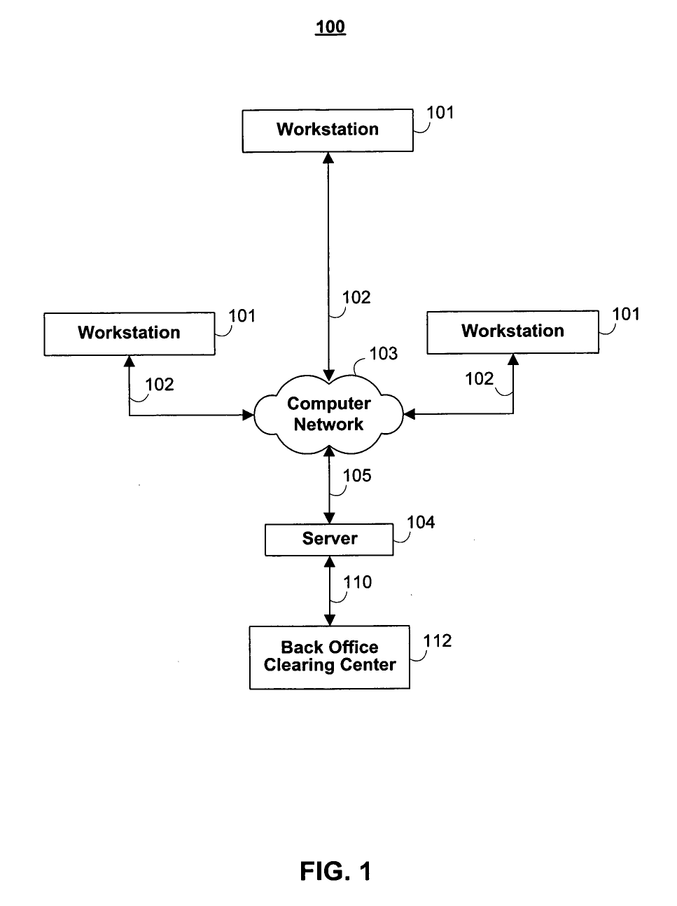

Referring to FIG. 1, exemplary system 100 for implementing the present invention is shown. As illustrated, system 100 may include one or more workstations 101. Workstations 101 may be local or remote, and are connected by one or more communications links 102 to computer network 103 that is linked via communications links 105 to server 104. Server 104 is linked via communications link 110 to back office clearing center 112.

In system 100, server 104 may be any suitable server, processor, computer, or data processing device, or combination of the same. Server 104 and back office clearing center 112 may form part of the electronic trading system. Furthermore, server 104 may also contain an electronic trading system and application programming interface and merely transmit a Graphical User Interface or other display screens to the user at the user workstation, or the Graphical User Interface may reside on Workstation 101.

Computer network 103 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 102 and 105 may be any communications links suitable for communicating data between workstations 101 and server 104, such as network links, dial-up links, wireless links, hard-wired links, etc.

Workstations 101 may be personal computers, laptop computers, mainframe computers, dumb terminals, data displays, Internet browsers, Personal Digital Assistants (PDAs), two-way pagers, wireless terminals, portable telephones, programmed computers having memory, the programmed computer using the memory for implementing trading models, etc., or any combination of the same. Workstations 102 may be used to implement the electronic trading system application and application programming interface according to the invention.

Back office clearing center 112 may be any suitable equipment, such as a computer, a laptop computer, a mainframe computer, etc., or any combination of the same, for causing transactions to be cleared and/or verifying that transactions are cleared. Communications link 110 may be any communications links suitable for communicating data between server 104 and back office clearing center 112, such as network links, dial-up links, wireless links, hard-wired links, etc.

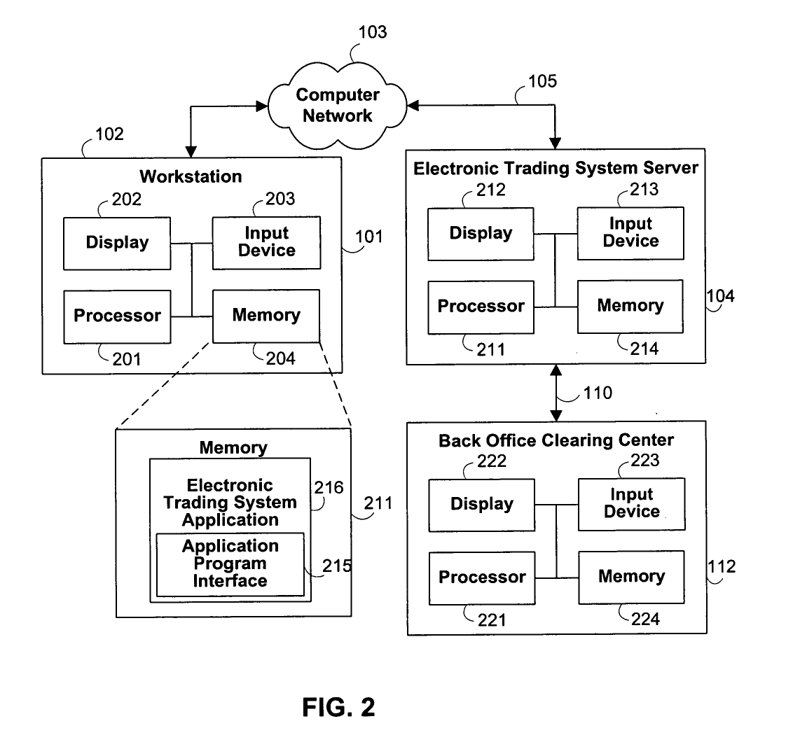

The server, the back office clearing center, and one of the workstations, which are depicted in FIG. 1, are illustrated in more detail in FIG. 2. Referring to FIG. 2, workstation 101 may include processor 201, display 202, input device 203, and memory 204, which may be interconnected. In a preferred embodiment, memory 204 contains a storage device for storing a workstation program for controlling processor 201. The storage device may include software stored on a suitable storage medium such as a disk. Memory 204 also preferably contains an electronic trading system application 216 according to the invention.

Electronic trading system application 216 may preferably include application program interface 215, or alternatively, as described above, electronic trading system application 216 may be resident in the memory of server 104. In this embodiment, the electronic trading system may contain application program interface 215 as a discrete application from the electronic trading system application which also may be included therein. The only distribution to the user may then be a Graphical User Interface which allows the user to interact with electronic trading system application 216 resident at server 104.

Processor 201 uses the workstation program to present on display 202 electronic trading system application information relating to market conditions received through communication link 102 and trading commands and values transmitted by a user of workstation 101. Furthermore, input device 203 may be used to manually enter commands and values in order for these commands and values to be communicated to the electronic trading system.

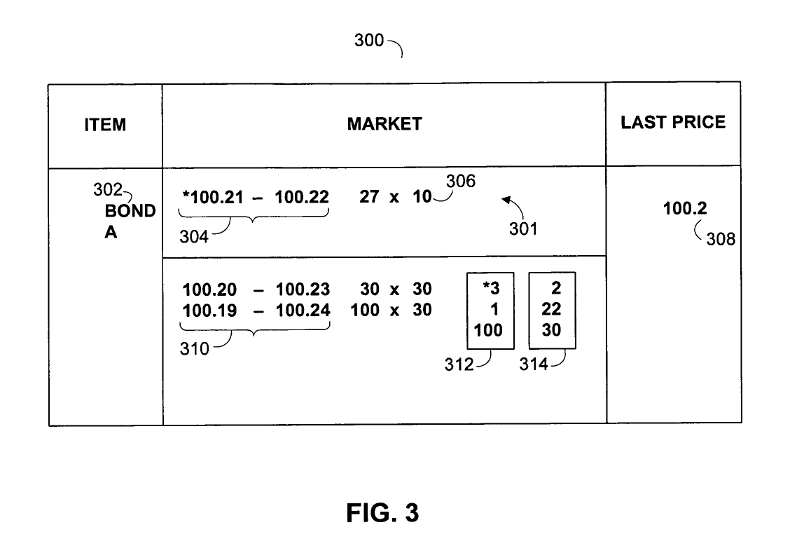

FIG. 3 shows an illustrative trading interface 300. Interface 300 is preferably for electronic trading and is adapted for implementing systems and methods according to the present invention. The interface includes a top line 301 (alternatively referred to herein as the touch line, or the headline.) Top line 301 may preferably be adapted to include the price that should be initially aggressed to start a trade or, alternatively, top line 301 may show the status of the actual aggressed trade. Top line 301 may include item 302, price 304, size 306 and last price 308. Interface 300 also includes market depth information 310, which shows price and size for items that have not yet been traded (commonly referred to as the order book, or, simply, the book). Also shown in interface 300 are bid and offer stacks 312 and 314, respectively. Bid and offer stacks 312 and 314 may indicate the size of one or many market participants are bidding or offering at the current price 304. Note that price 304 in this exemplary example is shown in a United States Government Bond pricing format.

Typically, an uncleared incoming order is marked by a visual indicator—e.g., an asterisk or other indicator preferably adjacent to the new order—e.g., adjacent to the price (See, asterisk in price 304 in FIG. 3). In the embodiment shown in FIG. 3, in the particular circumstance where only a portion of an order is not cleared, a visual indicator may be displayed in bid and offer stacks 312 and 314 adjacent the volume of a partially cleared order to indicate that only a portion of the order is cleared to be traded, or in some other suitable location which differentiates the partially cleared order from the totally uncleared order or from the totally clear order.

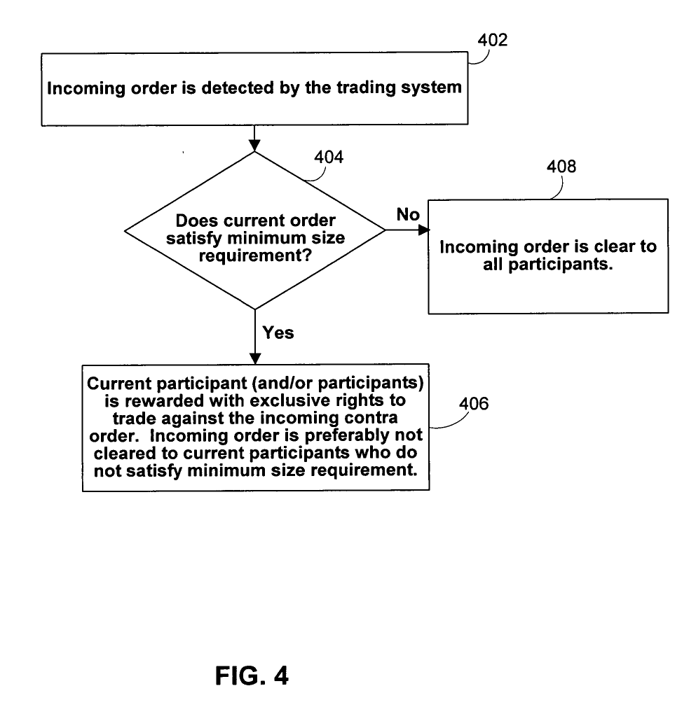

FIG. 4 is a flow chart that describes one embodiment of a method according to the invention. Step 402 shows that an incoming order is detected by the trading system. Step 404 queries whether a current order in the system satisfies a minimum size requirement. Step 406 shows that, if the current order satisfies the minimum size requirement, then the current participant associated with the current order is rewarded with exclusive rights to trade against the incoming contra order (assuming, in certain embodiments, that the current order has price/time priority over other current orders that also satisfy the minimum size requirement). If all current orders do not satisfy the minimum size requirement, then the incoming order is clear to all participants.

It should be noted that each of FIGS. 4-9 share similar steps X02, X06, and X08. The FIGs. are differentiated, for the most part, based on the query step of X04 in which each flow chart describes a unique query.

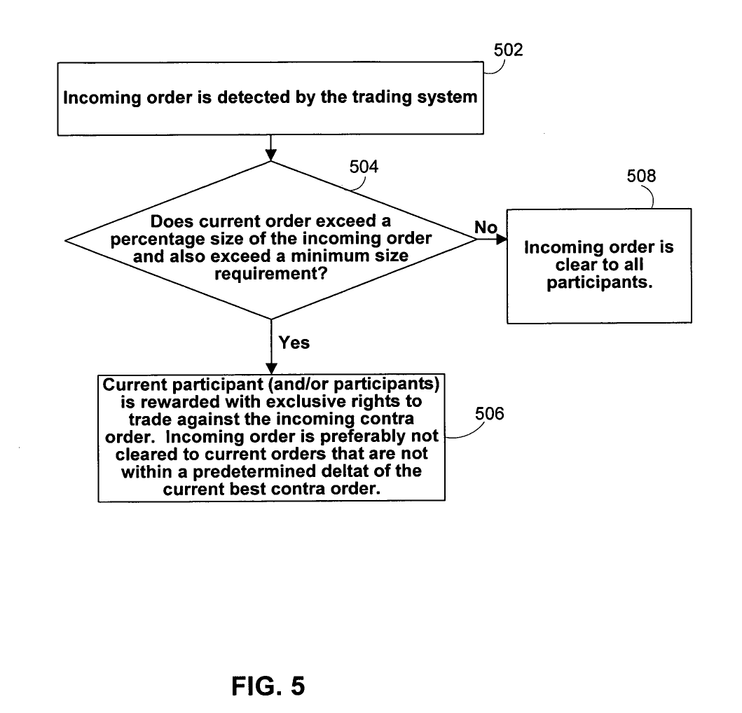

FIG. 5 is flow chart describing another embodiment of a method according to the invention. Query step 504 queries whether any current order exceeds a percentage size of the incoming order and also exceeds a minimum size requirement. If a current order does satisfy the query, then the current participant associated with the current order may, under certain circumstances, be awarded an exclusive or semi-exclusive right to trade with the incoming order.

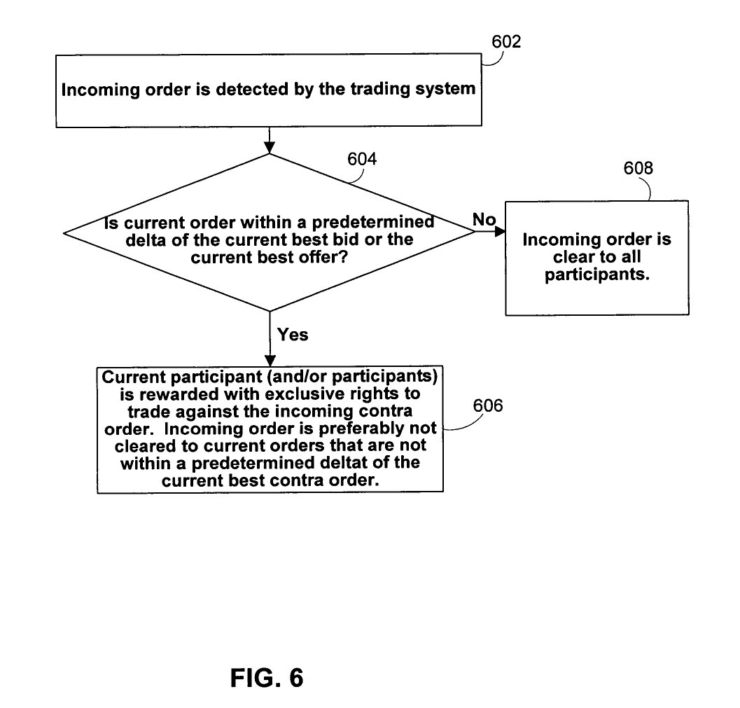

FIG. 6 is a flow chart describing yet another embodiment of a method according to the invention. Query step 604 queries whether any current order is within a predetermined delta, as described in more detail above, of the current best bid or the current best offer. If a current order is with the predetermined delta, then the current participant associated with the current order may, under certain circumstances, be awarded an exclusive or semi-exclusive right to trade with the incoming order.

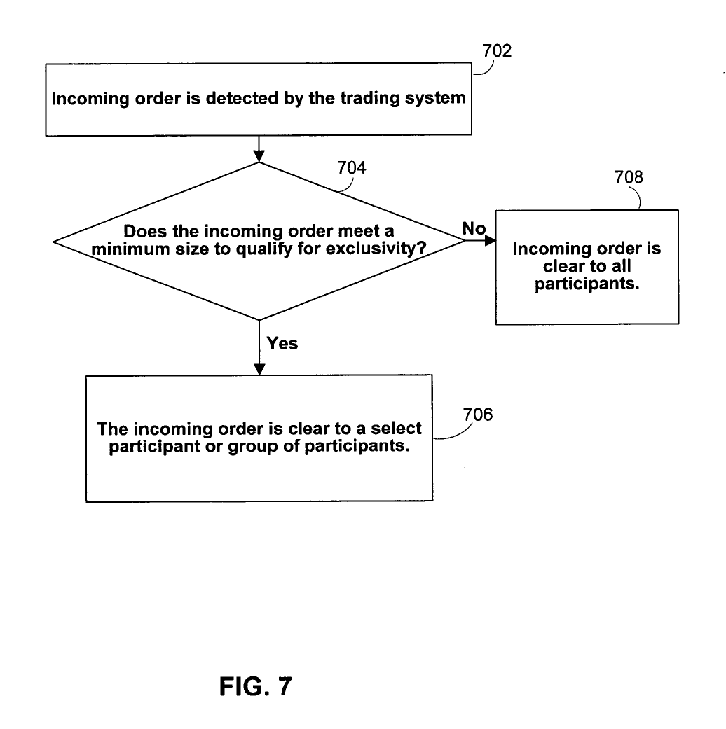

FIG. 7 is a flow chart describing still another embodiment of a method according to the invention. Step 704 queries whether an incoming order meets a minimum size to qualify for being clear only to a select participant or group of participants. If the incoming order meets the minimum size, then the incoming order may be clear to a select participant or group of participants.

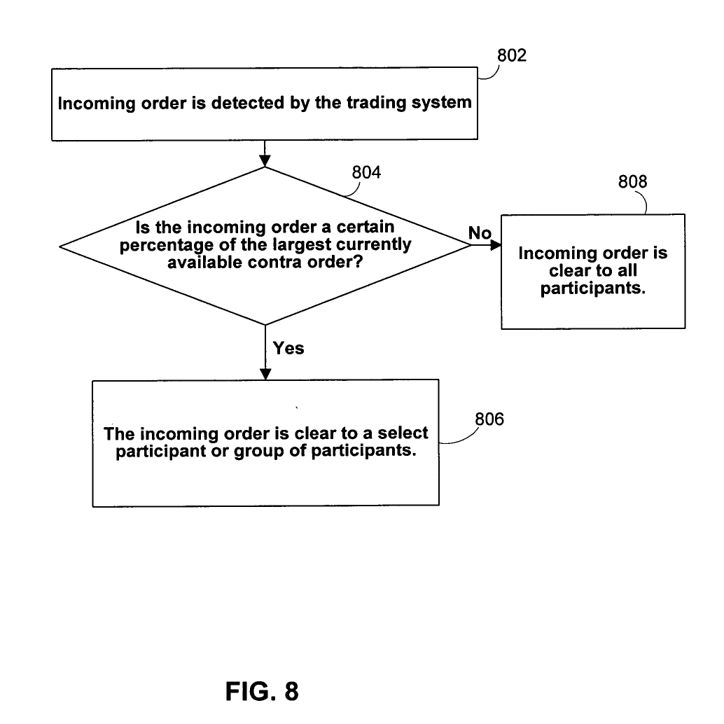

FIG. 8 is a flow chart describing yet another embodiment of a method according to the invention. Step 804 queries whether an incoming order is a certain, preferably predetermined, percentage of the largest currently available contra order, then the incoming order may be clear to a select participant or group of participants. If the incoming order is a certain percentage of the largest currently available contra order, then the incoming order may be clear to a select participant or group of participants.

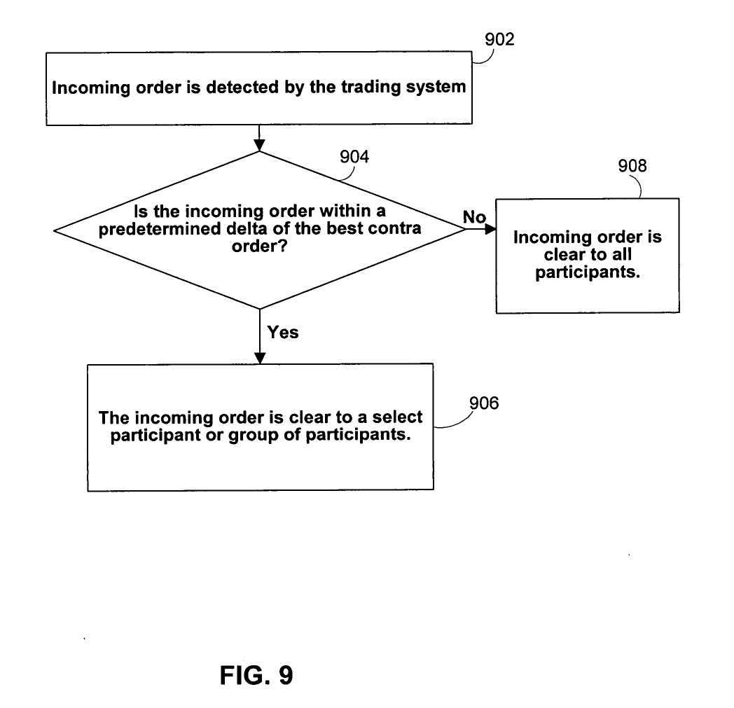

Finally, FIG. 9 is a flow chart describing another embodiment of a method according to the invention. Step 904 queries whether an incoming order is within a predetermined delta of the best contra order. If the incoming order is within a predetermined delta of the best contra order, then the incoming order may be clear to a select participant or group of participants.

It should be noted that each of the different query steps in FIGS. 4-9 may be used simultaneously with one another to provide multiple queries that are combined to determine whether any current order is rewarded with exclusivity. Thus, the trading system may query numerous different queries before a current participant associated with a current order is awarded exclusive or semi-exclusive rights to trade with an incoming order.

Thus, systems and method for defining criteria for obtaining exclusive priority in electronic trading systems have been provided. It will be understood that the foregoing is only illustrative of the principles of the invention, and that various modifications can be made by those skilled in the art without departing from the scope and spirit of the invention.

What is claimed is:

1. A method for trading an item in an electronic trading system, the method comprising:
receiving an incoming order;
determining whether a current order, the current order being contra to the incoming order, satisfies a set of predetermined criteria;
if the current order satisfies the set of predetermined criteria, presenting the incoming order for trading exclusively to the participant associated with the current order.

2. The method for trading an item according to claim 1 wherein the determining comprises querying whether the current order satisfies a minimum size requirement.

3. The method for trading an item according to claim 3 wherein the determining comprises querying whether the size of the current order exceeds a percentage of the size of incoming order.

4. The method for trading an item according to claim 1 wherein the determining comprises querying whether the current order is within a predetermined delta of the incoming order.

5. A method for trading an item in an electronic trading system, the method comprising:
receiving an incoming order;
determining whether the incoming order satisfies a set of predetermined criteria for being traded to a select group of participants;
if the incoming order satisfies the set of predetermined criteria, presenting the incoming order for trading to at least one select participant.

6. The method for trading an item according to claim 5 wherein the determining comprises querying whether the incoming order satisfies a minimum size requirement.

7. The method for trading an item according to claim 6 wherein the determining comprises querying whether the size of the incoming order exceeds a percentage of the size of best contra order.

8. The method for trading an item according to claim 5 wherein the determining comprises querying whether the incoming order is within a predetermined delta of the best contra order.

9. A computer system for trading an item in an electronic trading system, the computer system comprising:
a trade order receiving component for
receiving an incoming order;
determining whether a current order, the current order being resident in the system before the receiving of the incoming order and being contra to the incoming order, satisfies a set of predetermined criteria;
if the current order satisfies the set of predetermined criteria, presenting the incoming order for trading exclusively to the participant associated with the current order.

10. The system for trading an item according to claim 9 wherein the determining comprises querying whether the current order satisfies a minimum size requirement.

11. The system for trading an item according to claim 10 wherein the determining comprises querying whether the size of the current order exceeds a percentage of the size of incoming order.

12. The system for trading an item according to claim 9 wherein the determining comprises querying whether the current order is within a predetermined delta of the incoming order.

13. A computer system for trading an item in an electronic trading system, the computer system comprising:
a trade order receiving component for:
receiving an incoming order;
determining whether the incoming order satisfies a set of predetermined criteria for being traded to a select group of participants;
if the incoming order satisfies the set of predetermined criteria, presenting the incoming order for trading to at least one select participant.

14. The system for trading an item according to claim 13 wherein the determining comprises querying whether the incoming order satisfies a minimum size requirement.

15. The system for trading an item according to claim 14 wherein the determining comprises querying whether the size of the incoming order exceeds a percentage of the size of best contra order.

16. The system for trading an item according to claim 13 wherein the determining comprises querying whether the incoming order is within a predetermined delta of the best contra order.

17. A computer readable medium for trading an item in an electronic trading system, the computer readable medium comprising:
a first program code for receiving an incoming order;
a second program code for determining whether a current order, the current order being resident in the system before the receiving of the incoming order and being contra to the incoming order, satisfies a set of predetermined criteria;
a third program code for presenting the incoming order for trading exclusively to the participant associated with the current order if the current order satisfies the set of predetermined criteria.

18. The computer readable medium for trading an item according to claim 17 wherein the second program code for determining comprises querying whether the current order satisfies a minimum size requirement.

19. The computer readable medium for trading an item according to claim 18 wherein the second program code for determining comprises querying whether the size of the current order exceeds a percentage of the size of incoming order.

20. The computer readable medium for trading an item according to claim 17 wherein the second program code for determining comprises querying whether the current order is within a predetermined delta of the incoming order.

21. A computer readable medium for trading an item in an electronic trading system, the computer system comprising:
a first program code for receiving an incoming order;
a second program code for determining whether the incoming order satisfies a set of predetermined criteria for being traded to a select group of participants;
a third program code presenting the incoming order for trading to at least one select participant if the incoming order satisfies the set of predetermined criteria.

22. The computer readable medium for trading an item according to claim 21 wherein the second program code for determining further comprises querying whether the incoming order satisfies a minimum size requirement.

23. The computer readable medium for trading an item according to claim 22 wherein the second program code for determining comprises querying whether the size of the incoming order exceeds a percentage of the size of best contra order.

24. The computer readable medium for trading an item according to claim 21 wherein the second program code for determining comprises querying whether the incoming order is within a predetermined delta of the best contra order.
